(19) United States
(12) Patent Application Publication
(10) Pub. No.: US 2008/0303303 A1
(43) Pub. Date: Dec. 11, 2008

(54) Automobile Foldable Cargo Liner

(76) Inventor: Timothy Scott Valentine, Blackrod (GB)

Correspondence Address: PEARNE & GORDON LLP, 1801 EAST 9TH STREET, SUITE 1200, CLEVELAND, OH, 44114-3108, US

(21) Appl. No.: 10/583,755

(22) PCT Filed: Dec. 15, 2004
(86) PCT No.: PCT/GB2004/005248

§ 371 Date: Jun. 21, 2006

(30) Foreign Application Priority Data
Dec. 24, 2003 (GB) 0329876.7

(51) Int. Cl. B60R 13/01

(52) U.S. Cl. 296/39.1

(57) ABSTRACT

This invention relates to a vehicle load area liner comprising a sheet foldable to form a receptacle having a base and a wall around the base, the receptacle being arrangable in use to be mounted in the load area of a vehicle, and wherein at least a portion of the wall of the receptacle is unfoldable to provide a flap able to mask the threshold of the load area, when the vehicle load area is open, in use. The invention further provides a method of protecting a vehicle load area comprising the steps of:
(a) providing a liner of the invention; and in any order;
(b) folding a liner to form a receptacle; and
(c) mounting the liner on the floor of the vehicle load area.

This application claims the benefit of International Application Number PCT/GB2004/005248, which was published in English on Jul. 7, 2005.

### FIELD OF THE INVENTION

This invention relates to vehicle load area protectors, and especially but not exclusively to liners for protecting the load area of a car or van.

### BACKGROUND TO THE INVENTION

A vehicle load area, such as the cargo area of a van or boot of a car, can be damaged by items placed into the area. For example, heavy or bulky items, or items having sharp or protruding parts, may scratch or dent the interior of the area or the threshold to the load area. Damp or wet items placed into the load area may also damage the load area floor or any lining on the floor, such as a carpet or mat for example. Other sources of damage to a load area, and threshold thereto, include the entry and exit of persons or animals to and from the vehicle. Animals such as dogs can especially damage the threshold of the vehicle by scratching the surfaces of the threshold with their claws, and may further damage and dirty the interior of the load area once on board the vehicle.

Attempts have been made to prevent damage to the interior of load areas of vehicles by placing sheets of strong material on the floor of the load area, in order to prevent scratching, denting or other damage to the floor of the load area. Although such sheets can be effective in protecting the floor per se of the load area, they do not prevent spillage of liquids past the edges of the sheets, not do they prevent damage to the walls of the interior of the load area. In automobiles the rear surface of the rear passenger seats, which generally form the front wall of the load area, is especially vulnerable to damage as it generally comprises soft materials and upholstery, which is prone to ripping and staining.

Furthermore, such sheets do not prevent damage to the threshold of the load area, such as the vehicle load area sill, the rear door locking mechanism and rear bumper of the vehicle.

It would therefore be advantageous to provide a vehicle load area protector which could fit into the load area of a vehicle and protect the interior of the load area from damage, but could also protect the threshold of the load area when the load area is open.

It is therefore an aim of preferred embodiments of the invention to overcome or mitigate at least one problem of the prior art, whether expressly disclosed herein or not.

### SUMMARY OF THE INVENTION

According to a first aspect of the invention there is provided a vehicle load area liner comprising a sheet foldable to form a receptacle having a base and a wall around the base, the receptacle being arrangable in use to be mounted in the load area of a vehicle, and wherein at least a portion of the wall of the receptacle is unfoldable to provide a flap able to mask the threshold of the load area, when the vehicle load area is open, in use.

Thus a liner is provided that can form a receptacle which, due to its construction from a single folded sheet, is watertight between the base and the wall, but which can be manipulated to provide a threshold flap that enables protection of the threshold of the load area of a vehicle whilst allowing items to be inserted into the receptacle.

The sheet preferably comprises a substantially quadrilateral-shaped sheet material in its unfolded state. Preferably the sheet is substantially square or rectangular in shape, unfolded. The corners of the sheet material may be chamfered or fluted to enable efficient folding into the receptacle. Suitably the sheet comprises folds which enable the sheet to be folded such that the base of the receptacle is substantially quadrilateral-shaped, especially square or rectangular. The folds at the corners of the sheet material are preferably such that the corners are fluted to enable efficient folding of the wall of the sheet from the base. Suitably, the wall of the receptacle comprises a plurality of wall sections, separated by one or more folds.

Preferably the sheet comprises means to releasably retain the sheet in at least a partially folded configuration, and preferably a fully folded receptacle configuration. Suitably the retention means enable independent retention of the threshold flap on the receptacle, such that the flap can be maintained as part of the wall of the receptacle, and released by a user to form the flap when desired. The retention means may comprise any suitable means such as male and female connection means located on suitable areas of the sheet. The male and female retention means may comprise press studs, hook and loop material such as Velcro®, tongue and groove combinations and the like for example. When the sheet comprises fluted portions at the corners of the sheet the male and female retention means may be located on adjacent sections either sided of the fold(s) of the fluted area. When the sheet comprises a plurality of wall portions separated by fold lines, suitably each wall portion comprises means to releasably retain the wall portion folded next to adjacent portions.

The folds may be oriented such that the wall of the receptacle is taller at one or more portions. Preferably the sheet is square or rectangular and the folds are oriented such that one wall of the folded receptacle is taller than the other walls. In this way, for automobile load areas, the receptacle can be positioned such that the taller wall abuts the rear surface of the passenger seats to protect the seats from damage, for example.

The wall may comprise a portion which is doubled back or folded on itself, such that it may be unfolded to create a wall portion taller than the remainder of the wall.

In this way, the doubled-back portion may be positioned, for example, against the rear seat adjacent to a load area of a vehicle, and unfolded, such that it can be draped at least partly over the apex of the rear seat, to protect the rear seat apex.

The doubled-back portion may include means to connect the portion to the apex of a rear seat, such as apertures or male or female connection means, capable of connecting with a head-rest or other protrusion on the rear seat, for example.

Preferably one or more of the walls of the folded receptacle may be detachable from the receptacle, such that it can, for example, be utilised elsewhere in the vehicle to provide protection for another surface of the vehicle, such as the trim of the rear seats of the vehicle, for example. Preferably the portion of the folded receptacle which is detachable is detachably connected to the sheets of the vehicle load area liner by way of any suitable connection means, including for example press-studs, hook and loop material such as Velcro®, tongue and groove combinations and the like.

The sheet may comprise gripping means to grip the load area floor in use. The gripping means are preferably located on the outside of the base area of the receptacle when folded. The gripping means may comprise a rough key, tacky material or the like, able to grip both a bare load area floor or a lining, such as a mat or carpet located on the load area floor. The gripping means may comprise separate gripping means connected to the sheet, or integral gripping means forming part of the sheet.

Preferably the sheet is constructed from plastics. Suitable plastics include polyalkylenes (such as polypropylene and polyethylene, for example) polyurethane, polyester, polyvinylchloride, co-polymers and mixtures thereof for example. The sheet may be constructed from other materials, a combination of materials, including, for example, paper, cardboard, metals (including alloys), or any mixtures thereof.

According to a second aspect of the present invention there is provided a method of protecting a vehicle load area comprising the steps of:
(a) providing a liner of the first aspect of the invention; and in any order
(b) folding the liner to form a receptacle;
(c) mounting the liner on the floor of the load area

The method may comprise unfolding the threshold flap of the receptacle to mask the threshold of the load area. Suitably the threshold flap is of dimensions such that, when unfolded, it protrudes past the threshold of the vehicle load area.

Suitably the method comprises the step of loading goods into the load area, then folding the threshold flap back onto the receptacle to form the complete receptacle round the loaded goods.

Suitably the vehicle is an automobile. Preferably the automobile is a car or a van, but may be a minibus, caravan or the like, for example.

According to a third aspect of the invention there is provided a method of the second aspect of the invention, using a liner of the first aspect of the invention.

### BRIEF DESCRIPTION OF THE DRAWINGS

For a better understanding of the various aspects of the invention and to show how embodiments of the same may be put into effect, the invention will now be described by way of example only, with reference to the accompanying drawings, in which:

FIG. 1 illustrates a part top plan, part perspective view of an embodiment of a vehicle load area liner of the invention in an unfolded orientation;

FIG. 2 illustrates the liner of FIG. 1 partly folded and mounted in the load area of an automobile, with the threshold flap masking the threshold; and

FIG. 3 illustrates the liner of FIG. 1 fully folded and mounted in the load area of an automobile to form a receptacle

### DESCRIPTION OF THE PREFERRED EMBODIMENT

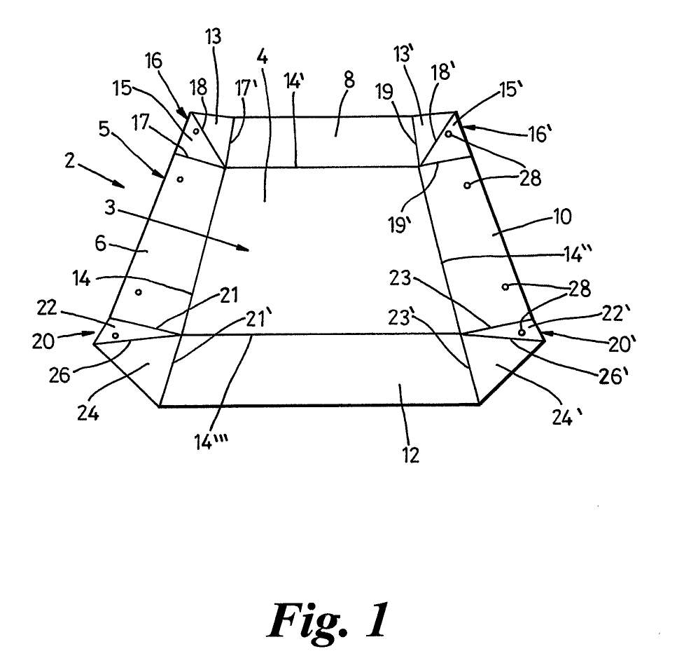

We refer firstly to FIG. 1 which illustrates a preferred embodiment of a vehicle load area liner 2 of the invention. The liner 2 comprises a substantially rectangular sheet 3. The sheet 3 includes folds 14, 14′, 14″, 14′″ which define a central base 4 of the sheet 3 and a surrounding wall 5. The wall 5 comprises four rectangular wall sections 6, 8, 10, 12 on each side of the rectangular base 4, the wall sections being connected via corner segments 16, 16′, 20,20′. The corner segments are integral with the wall sections and connected to the wall sections via a pair of perpendicular fold lines 17-17′, 19-19′, 21-21′, 23-23′, each pair of fold lines defining the corner segment between two adjacent wall sections. The corner segments further comprise a transverse fold line 18, 18′, 26, 26′ running from the intersection of each pair of fold lines 17-17′, 19-19′, 21-21′, 23-23′ to the distal edge of each corner 16, 16′, 20, 20′. Thus the transverse fold lines 18, 18′, 26, 26′ serve to bisect the corner segments into chamfered or fluted segments having two substantially triangular segments each (13 & 15, 13′& 15′, 22 & 24 and 22′ & 24′) extending from the transverse fold lines 18, 18′, 26, 26′.

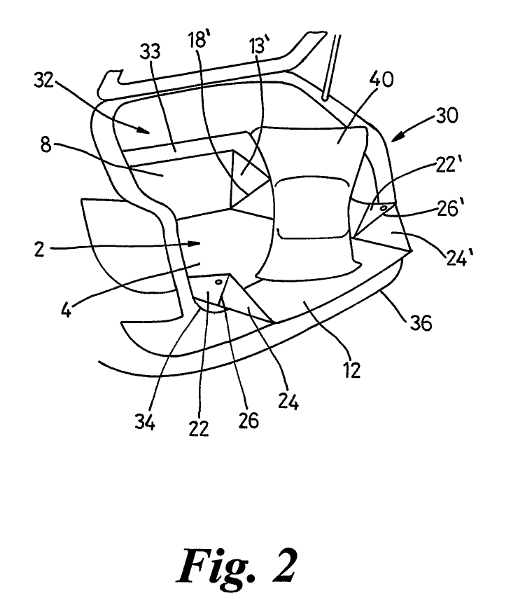

The sheet 3 can thus be folded about all of the folds (14, 14′, 14″, 14′″, 17, 17′, 19′ 19′, 21, 21′, 23, 23′, 18, 18′, 26, 26′) to form a receptacle in the form of a rectangular box, as shown in FIG. 2. The receptacle is watertight as the corners of the receptacle comprise folds rather than connected edges, and thus any liquid within the box cannot leak from the corners.

The wall sections 6, 8, 10, 12 also comprise means to retain the folded sheet 3 as a receptacle, the retaining means being in the form of press studs 28 which cooperate with press studs 28 present on the segments 15, 15′, 22, 22′ of the corner segments 16, 16′, 20, 20′, as shown in FIG. 1.

Use of the vehicle load area liner 2 will now be described by reference to FIGS. 2 & 3. We turn now to FIG. 2.

The sheet 3 is folded about all of the fold lines to form the receptacle as described above and the folded receptacle secured by retaining it in the folded configuration using the press studs 28. The folded receptacle is then inserted into the load area 32 of an automobile 30, such that it substantially covers the floor 38 of the load area 32. The wall 12 is oriented adjacent to the threshold 34 of the load area 32. When it is desired to insert an object into the receptacle a user releases the press studs 28 which are retaining the wall 12 in position on the receptacle, then unfolds the wall 12 away from the receptacle such that it lies parallel with the floor of the load area 32, forming a threshold flap, masking the threshold 34, as shown in FIG. 2. The wall 12 thus serves as a threshold flap which masks the threshold. An object 40, such as a heavy bag of moist sand for example, can then be lifted onto the wall 12 and slid onto the base 4 of the receptacle. As the wall 12 serves to mask the threshold 34, including the lock 39 for the rear door of the vehicle and the rear bumper 36, the object 40 cannot damage the threshold 34 or floor of the load area 32 during insertion into the load area 32.

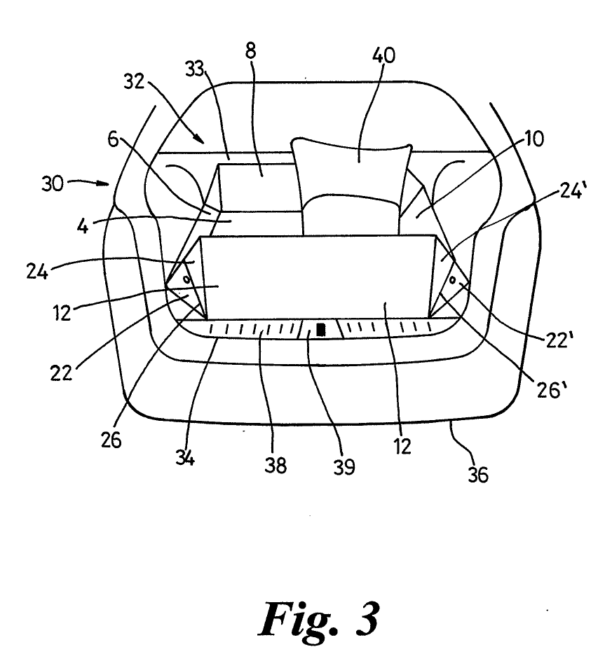

When the object 40 is fully inserted into the receptacle the wall 12 can be folded back onto the receptacle and secured using the press studs 28, as shown in FIG. 3. The receptacle is watertight and therefore, if there is leakage from the object during transit in the load area 32, then the floor of the load area 32 will not be affected.

The wall 12, when folded down to form the threshold flap can also serves as a mask to prevent damage from a person or animal climbing into the load area 32. Furthermore the threshold flap can support a user sitting on the threshold 34.

The wall 8 opposite to the wall 12 serves to mask the rear surface of the rear seat 33 of the vehicle 30, thus protecting the material of the seat 33 from damage caused by inserting objects into the load area 32. in alternative embodiments, the wall 8 may be detachable so that it can be used to protect other surfaces of the vehicle such as the seats trim. The wall 8 may be detachably connected by way of press-studs, Velcro® or the like, for example.

The liner 2 can just as easily be utilised in a van or lorry load area as an automobile load area.

The liner 2 is preferably made from a strong plastics material which can withstand wear and tear from multiple insertions and withdrawals of heavy or sharp objects into the folded receptacle, for example.

The liner is also conveniently cleaned by unfolding the sheet 3 and brushing or wiping the sheet to remove dirt and debris. The liner 2 can also be stored conveniently by hanging the folded or unfolded liner 2 in a garage or other similar structure, or by placing the unfolded sheet flush against a wall for example. The liner 2 may comprise means to enable the liner 2 to be hung from a suitable protrusion. The hanging means may comprise an aperture or loop which in use is co-operable with a protrusion, such as a hook, or nail, for example.

In other embodiments the wall 8 may comprise a wall taller than all of the other walls 6, 10, 12 of the liner 2. The wall 8 may comprise a doubled-back portion (not shown) folded down towards the base 4, which may be unfolded to enable the wall 8 to be taller than the other walls 6, 10, 12. The doubled-back portion can then be used to cover the rear surface and apex of the rear seat 33, for example, to protect the seat 33 from damage.

The wall 8 and/or double-backed portion may include means to enable it to be connected to the apex of the rear seat 33, such as apertures or male or female connection means (not shown) which enable the wall 8 to co-operate with protrusions, such as a head-rest, or the seat 33, for example.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A vehicle load area liner comprising a sheet foldable to form a receptacle having a base and a wall around the base, the receptacle being arrangable in use to be mounted in the load area of a vehicle, and wherein at least a portion of the wall of the receptacle is unfoldable to provide a flap able to mask the threshold of the load area, when the vehicle load area is open, in use.

2. A vehicle load area liner as claimed in claim 1 wherein a sheet comprises a substantially quadrilateral-shaped sheet material in its unfolded state.

3. A vehicle load area liner as claimed in claim 1 wherein the corners of the sheet material are chamfered or fluted to enable efficient folding into the receptacle.

4. A vehicle load area liner as claimed in claim 1 wherein the sheet comprises folds which enable the sheet to be folded such that the base of the receptacle is substantially quadrilateral-shaped.

5. A vehicle load area liner as claimed in claim 3 wherein the folds at or near the corners of the sheet material are oriented such that the corners are fluted to enable efficient folding of the wall of the sheet from the base.

6. A vehicle load area liner as claimed in claim 1 further comprising means to releasably retain the sheet in at least a partially folded configuration.

7. A vehicle load area liner as claimed in claim 6 wherein the retention means enable independent retention of the threshold flap on the receptacle, such that the flap can be maintained as part of the wall of the receptacle, and released by user to form a flap when desired.

8. A vehicle load area liner as claimed in claim 1 wherein the folds are oriented such that the wall of the receptacle is taller at one or more portions.

9. A vehicle load area liner as claimed in claim 1 wherein the sheet is square or rectangular and the folds are oriented such that one wall of the folded receptacle is taller than the other walls.

10. A vehicle load area liner as claimed in claim 1 wherein at least a portion of the wall is folded back on itself to form a double-backed portion capable of being unfolded to form a wall portion taller than the other wall portions.

11. A vehicle load area liner as claimed in claim 1 wherein the sheet further comprises gripping means capable of gripping a load area floor in use.

12. A vehicle load area liner as claimed in claim 1 constructed from plastics, paper, card, metal or any mixture thereof.

13. A method of protecting a vehicle load area comprising the steps of:
(a) providing a liner of claim 1;
(b) folding the liner to form a receptacle; and
(c) mounting the liner on the floor of the vehicle load area.

14. A method as claimed in claim 13 further comprising unfolding the threshold flap of the receptacle to mask the threshold of the vehicle load area.

15. A method as claimed in claim 13 wherein the threshold flap is of dimensions such that, when unfolded, it protrudes past the threshold of the vehicle load area.

16. A method as claimed in claim 13 further comprising the step of loading goods into the vehicle load area, and folding the threshold flap back onto the receptacle to form a complete receptacle around the loaded goods.
